(19) United States
(12) Patent Application Publication
(10) Pub. No.: US 2025/0289914 A1
(43) Pub. Date: Sep. 18, 2025

(54) PROCESS FOR PREPARING A PROPYLENE COMPOSITION

(71) Applicant: SABIC GLOBAL TECHNOLOGIES B.V., Bergen op Zoom (NL)

(72) Inventors: Tinashe Victor Mandishonha NDORO, Maastricht (NL); Henrica Norberta Alberta Maria STEENBAKKERS-MENTING, Susteren (NL); Martin Alexander ZUIDEVELD, Kelmis (BE); Marios LAGOIDIS, Limburg (NL); Akhlaq MOMAN, Riyadh (SA); Abderrahman MEDDAD, Riyadh (SA)

(21) Appl. No.: 18/863,108

(22) PCT Filed: May 5, 2023
(86) PCT No.: PCT/EP2023/061897

§ 371 Date: Nov. 5, 2024

(30) Foreign Application Priority Data
May 6, 2022 (EP) 22172166.5

(51) Int. Cl. C08F 10/06; C08F 4/646; C08F 4/651; C08F 4/656

(52) U.S. Cl. CPC C08F 10/06; C08F 4/646; C08F 4/651; C08F 4/656

(57) ABSTRACT

The invention relates to Process for the preparation of a polypropylene composition comprising a propylene-based polymer which is a propylene homopolymer or propylene-ethylene copolymer having an ethylene content of less than 1.0 wt % based on the propylene-ethylene copolymer, wherein the polypropylene composition has • a melt flow rate (MFR) in the range from 0.50 to 110 dg/min, wherein the melt flow rate is determined using 1501133-1:2011 using 2.16 kg at 230° C., wherein the process comprises the step of polymerizing propylene and optional ethylene comonomers in the presence of a catalyst in a gas phase to obtain the propylene-based polymer, wherein said catalyst comprises a procatalyst, a cocatalyst and optionally an external electron donor, wherein the procatalyst is obtainable by a process comprising the steps of: • contacting a magnesium-containing support with a halogen containing titanium compound, and an internal electron donor according to Formula (I) wherein R¹ is a secondary alkyl group and R² is a non-secondary alkyl group having at least 5 carbon atoms, preferably R is a non-secondary alkyl group being branched at the 3-position or further positions; said procatalyst is prepared according to the following steps: ⋅ i) contacting a compound R4zMgX 4_{2-z} with an alkoxy- or aryloxy-containing silane compound to give a first intermediate reaction product, being a solid Mg(OR^{a}) X¹₂₋ₓ₋wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an N integer between 0 and 2; ii) optionally contacting the solid Mg(OR^{a})xX1₂₋ₓ obtained in step i) with at least one activating compound selected from the group formed by activating electron donors and metal alkoxide compounds of formula M¹(OR^{b})_{v-w}(OR³)w or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4; iii) contacting the first or second intermediate reaction product, obtained respectively in step i) or ii), with a halogen-containing Ti— compound and said compound represented Formula (I), as the internal electron donor.

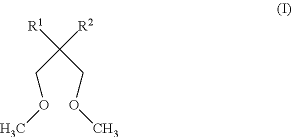

### TECHNICAL FIELD

The present invention relates to a process for the preparation of a composition comprising a propylene-based polymer which is a propylene homopolymer or propylene-ethylene copolymer having an ethylene content of at most 1.0 wt % based on the propylene-ethylene copolymer.

Further, the present invention is also directed to an article comprising the inventive polypropylene composition. Further, the invention relates to the use of said polypropylene composition as well as to a process for the preparation of said article. The invention further relates to use of the inventive polypropylene composition for compounding with a further polymer or making masterbatches.

### BACKGROUND

Polymers, like polypropylene, are increasingly used in different demanding applications. At the same time, there is a continuous search for tailored polymers which meet the requirements of these applications, for instance of a high stiffness (as illustrated by a high isotacticity and low CXS. In addition, there is a continuous drive for high yield processes as this is economically more favorable.

Therefore there is a need in the art for a process for the preparation of a polypropylene composition comprising a propylene-based polymer which is a propylene homopolymer or propylene-ethylene copolymer having an ethylene content of at most 1.0 wt % based on the propylene-ethylene copolymer having a high stiffness which can be produced with a high catalyst yield.

### SUMMARY

It is therefore an object of the present invention to provide a process for the preparation of a polypropylene composition comprising a propylene-based polymer which is a propylene homopolymer or propylene-ethylene copolymer having an ethylene content of less than 1.0 wt % based on the propylene-ethylene copolymer having a high stiffness which can be produced with a high catalyst yield.

This object is achieved by a process for the preparation of a polypropylene composition comprising a propylene-based polymer which is a propylene homopolymer or propylene-ethylene copolymer having an ethylene content of at most 1.0 wt % based on the propylene-ethylene copolymer, wherein the polypropylene composition has preferably at least than 95 wt %, more preferably at least than 96 wt %, even more preferably at least than 97 wt %, even more preferably at least than 98 wt % of propylene-based polymer based on the composition and:
a melt flow rate (MFR) in the range from 0.50 to 110 dg/min, wherein the melt flow rate is determined using IS01133-1:2011 using 2.16 kg at 230° C. and
   wherein the process comprises the step of polymerizing propylene and optional ethylene comonomers in the presence of a catalyst in a gas phase to obtain the propylene-based polymer, wherein said catalyst comprises a procatalyst, a co-catalyst and optionally an external electron donor, wherein the procatalyst is obtainable by a process comprising the steps of:
   contacting a magnesium-containing support with a halogen-containing titanium compound, and an internal electron donor according to Formula I:

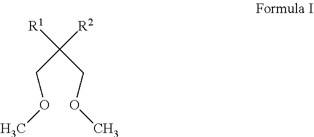

wherein R¹ is a secondary alkyl group and R² is a non-secondary alkyl group having at least 5 carbon atoms, preferably R² is a non-secondary alkyl group being branched at the 3-position or further positions, said procatalyst is prepared according to the following steps:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
iii) contacting the first or second intermediate reaction product, obtained respectively in step i) or ii), with a halogen-containing Ti-compound and said compound represented Formula I, as the internal electron donor.

The invention further provides the polypropylene composition obtainable by or obtained by the process according to the invention.

The invention further provides a polypropylene composition comprising a propylene-based polymer which is a propylene homopolymer or propylene-ethylene copolymer having an ethylene content of at most 1.0 wt % based on the propylene-ethylene copolymer,

wherein the polypropylene composition has
a melt flow rate (MFR) in the range from 0.50 to 110 dg/min, wherein the melt flow rate is determined using IS01133-1:2011 using 2.16 kg at 230° C. and
wherein the amount of Ti in the propylene-based polymer is at most 1.1 mg per 1 kg of the propylene-based polymer as determined by Inductively coupled plasma mass spectrometry (ICP-MS).

According to the invention, it was surprisingly found that the use of a specific catalyst in the process for the preparation of a propylene-based polymer results in a combination of a high catalyst yield and a high isotacticity of the composition. Due to the use of such low amounts of catalyst, a polypropylene composition can be produced having very low amounts of Ti. Therefore, in a further aspect, the invention provides a polypropylene composition having a low amount of Ti from the catalyst used in the preparation of the composition, which is advantageous for the high purity of the composition.

### DESCRIPTION OF EMBODIMENTS

### Propylene-Based Polymer

The polypropylene composition according to the invention comprises a propylene-based polymer which is a propylene homopolymer or propylene-ethylene copolymer having an ethylene content of less than 1.0 wt % based on the propylene-ethylene copolymer.

Preferably, the polypropylene composition has a melt flow rate (MFR) from 0.50 to 110 dg/min, more preferably from 0.5 to 50 dg/min as determined according to ISO1133-1:2011 using 2.16 kg at 230° C.

Preferably, the propylene-based polymer has a cold xylene soluble content (CXS) in the range from 1.0 to 5.0, more preferably in the range from 1.0 to 4.0 wt %, more preferably in the range from 1.0 to 3.0 wt % as measured by the method described in the section “CRYSTEX method for propylene homopolymer” of the Measurement methods section of the present disclosure.

Preferably, the propylene-based polymer has a pentad isotacticity of at least 95.5 wt. %, preferably of at least 96 wt %, wherein the pentad isotacticity is determined using ¹³C NMR and/or a melt flow rate (MFR_{Hopol}) as determined according to IS01133-1:2011 using 2.16 kg at 230° C. in the range from 2 to 100 dg/min.

Preferably, the polypropylene composition has a molecular weight distribution (Mw/Mn) in the range from 1.0 to 11.0, more preferably in the range from 4.0 to 9.0, wherein Mw stands for the weight average molecular weight and Mn stands for the number average weight and wherein Mw and Mn are measured according to ISO16014-1(4):2003.

### Process for the Preparation of the Propylene-Based Polymer

The person skilled in the art is aware of how to prepare a propylene homopolymer or propylene-ethylene copolymer. The preparation of propylene homopolymers and propylene-ethylene copolymers is for example described in Moore, E. P. (1996) Polypropylene Handbook. Polymerization, Characterization, Properties, Processing, Applications, Hanser Publishers: New York.

### Catalyst

The catalyst used for the preparation for the polypropylene composition according to the invention is the catalyst described in detail in WO2021/063930, incorporated herein by reference. The catalyst comprises a procatalyst, a co-catalyst and optionally an external electron donor.

The procatalyst is obtainable by a process comprising contacting a magnesium-containing support with a halogen-containing titanium compound, and an internal electron donor according to Formula I:

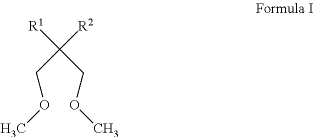

wherein R¹ is a secondary alkyl group and R² is a non-secondary alkyl group having at least 5 carbon atoms, preferably R² is a non-secondary alkyl group having at least 5 carbon atoms and being branched at the 3-position or further positions.

The process for providing said procatalyst follow the one describe in WO2021/063930A1 (which in incorporated by reference) and comprises the steps of:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
iii) contacting the first or second intermediate reaction product, obtained respectively in step i) or ii), with a halogen-containing Ti-compound and said compound represented Formula I, as the internal electron donor.

In an embodiment, during step ii) as activating compounds an alcohol is used as activating electron donor and titanium tetraalkoxide is used as metal alkoxide compound.

In an embodiment, an activator is present. In an embodiment, said activator is ethyl benzoate. In an embodiment, said activator is a benzamide according to formula X:

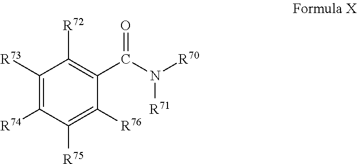

wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, preferably selected from alkyl, alkenyl, aryl, aralkyl, alkoxycarbonyl or alkylaryl groups, and one or more combinations thereof, more preferably wherein R⁷⁰ and R⁷¹ are both methyl and wherein R⁷², R⁷³, R⁷⁴, and R⁷⁵ are all hydrogen, being N,N′-dimethylbenzamide (Ba-2Me).

Preferably, the internal electron donor used is according to Formula I:

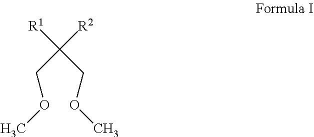

wherein R¹ is a secondary alkyl group having at least three carbon atoms and R² is a non-secondary alkyl group having at least 5 carbon atoms, preferably R¹ et R² is having at most seven carbon atoms, preferably at most six carbon atoms, preferably iso-propyl, iso-butyl, iso-pentyl, cyclopentyl, n-pentyl, and iso-hexyl, preferably R² is being branched at the 3-position or further positions.

In another embodiment, the internal electron donor is 3,3-bis(methoxymethyl)-2,6-dimethyl heptane, according to Formula I wherein R¹ is iso-propyl being secondary alkyl and R² is iso-pentyl being non-secondary and having a branch on the third carbon atom (abbreviated as iPiPen, wherein iP stands for iso-propyl and iPen stands for iso-pentyl, also known as 3-methyl-butyl). This compound iPiPen has a chemical formula of C₁₃H₂₈O₂; an exact mass of 216.21 and a molecular weight of 216.37. In a more preferred embodiment of the invention, iPiPen is used as internal donor and/or wherein the activating compound is preferably N,N-dimethylbenzamide.

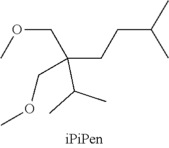

In another embodiment, the internal electron donor is (1-methoxy-2-(methoxymethyl)-5-methylhexan-2-yl)cyclopentane, according to Formula I wherein R¹ is secondary alkyl cyclopentyl and R² is secondary cyclopentyl (abbreviated as CPiPen, wherein CP stands for cyclopentyl and iPen stands for iso-pentyl, also known as 3-methyl-butyl). This compound CPiPen has a chemical formula of C₁₅H₃₀O₂; an exact mass of 242.22 and a molecular weight of 242.40. In a more specific embodiment, CPiPen is used as internal donor and N,N-dimethylbenzamide is preferably used as activator.

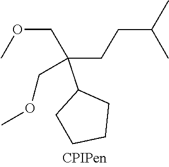 [SMILES: COCC(CCC(C)C)(COC)C1CCCC1]

In another embodiment, the internal electron donor is 3,3-bis(methoxymethyl)-2,7-dimethyloctane, according to Formula I wherein R¹ is the secondary alkyl iso-propyl and R² is non-secondary iso-hexyl with a branch on the four carbon atom (abbreviated as iPiHex, wherein iP stands for iso-propyl and iHex stands for iso-hexyl, also known as 4-methyl-pentyl). This compound iPiHex has a chemical formula of C₁₄H₃₀O₂; an exact mass of 230.22 and a molecular weight of 230.39. In a more specific embodiment, iPiHex is used as internal donor and N,N-dimethylbenzamide is preferably used as activator.

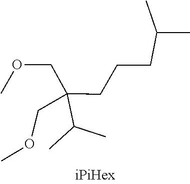 [SMILES: COCC(CCCC(C)C)(COC)C(C)C]

In another embodiment, the internal electron donor is 3,3-bis(methoxymethyl)-2-methyloctane, according to Formula I wherein R¹ is secondary alkyl iso-propyl and R² is non-secondary non-branched n-pentyl (abbreviated as iPnPen, wherein iP stands for iso-propyl and nPen stands for n-pentyl). This compound iPnPen has a chemical formula of C₁₃H₂₈O₂; an exact mass of 216.21 and a molecular weight of 216.37. In a more specific embodiment, iPnPen is used as internal donor and N,N-dimethylbenzamide is preferably used as activator.

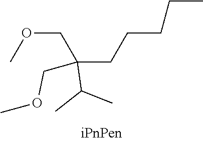

In another embodiment, the internal electron donor is 3,3-bis(methoxymethyl)-2,6-dimethyloctane, according to Formula I wherein R¹ is secondary alkyl iso-propyl and R² is non-secondary branched hexyl having a branch at the third carbon atom (abbreviated as iP3Hex, wherein iP stands for iso-propyl and wherein 3Hex stands for hexyl having a branch at the third carbon atom, also known as 3-methyl-pentyl). This compound iPiHex has a chemical formula of C₁₄H₃₂O₂; an exact mass of 230.22 and a molecular weight of 230.39. In a more preferred embodiment, iP3Hex is used as internal donor and/or N,N-dimethylbenzamide is preferably used as activator.

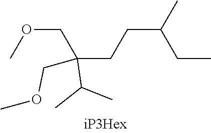 [SMILES: CCC(C)CCC(COC)(COC)C(C)C]

In another embodiment, the procatalyst used according to the present invention provides a polymer yield of at least 50 kg polymer per gram of procatalyst used.

In an embodiment, the substituent R¹ is isopropyl or cyclopentyl. In an embodiment, the substituent R² is isopentyl or isohexyl. The below table shows the embodiments above with their abbreviations and the R¹ and R² groups as well if these groups are secondary or not and branched or not.

According to the present invention, it is further preferred that R¹ is a secondary alkyl group and R² is a non-secondary alkyl group being branched at the 3-position or further positions.

| | R¹ | | | R² | | |
|---|---|---|---|---|---|---|
| Abbrev | secondary | branched | # C | secondary | branched | # C |
| iPiPen | Yes (iP) | Yes at 1 | 3 | No (iPen) | Yes at 3 | 5 |
| CPiPen | Yes (CP) | Yes at 1 | 5 | No (iPen) | Yes at 3 | 5 |
| iPiHex | Yes (iP) | Yes at 1 | 3 | No (iHex) | Yes at 4 | 6 |
| iPnPen | Yes (iP) | Yes at 1 | 3 | No (nPen) | No | 5 |
| iP3Hex | Yes (iP) | Yes at 1 | 3 | No (3Hex) | Yes at 3 | 6 |

Preferably, the catalyst comprises the external electron donor and the molar ratio of co-catalyst to external electron donor is more than 1 and at most 120 or more than 3 and at most 90.

Preferably, the co-catalyst is selected from the group consisting of trimethylaluminum, triethylaluminum, triisobutylaluminum, trihexylaluminum, di-isobutylaluminum hydride, trioctylaluminium, dihexylaluminum hydride and mixtures thereof.

Preferably, the external electron donors are chosen from the group of compounds having a structure according to:
Formula III: (R⁹⁰)₂N-Si(OR⁹¹)₃,
Formula IV: (R⁹²)Si(OR⁹³)₃,
Formula V: Si(OR^{a})₄-nR^{b}n, and
mixtures thereof,
   wherein each of R⁹⁰, R⁹¹, R⁹² and R⁹³ groups are each independently a linear, branched or cyclic, substituted or unsubstituted alkyl having between 1 and 10 carbon atoms, preferably wherein R⁹⁰, R⁹¹, R⁹² and R⁹³ groups are each independently a linear unsubstituted alkyl having between 1 and 8 carbon atoms, wherein n can be from 0 up to 2, and each of R^{a} and R^{b}, independently, represents an alkyl or aryl group, optionally containing one or more hetero atoms for instance O, N, S or P, with, for instance, 1-20 carbon atoms

Preferably, the molar ratio of Al in the co-catalyst to Si in the external electron donor is more than 1 and at most 120 or more than 3 and at most 90.

for example ethyl, methyl or n-propyl, for example diethylaminotriethoxysilane (DEATES), n-propyl triethoxysilane, (nPTES), n-propyl trimethoxysilane (nPTMS); and organosilicon compounds having general formula Si(OR^{a})₄₋ₙR^{b}ₙ, wherein n can be from 0 up to 2, and each of R^{a} and R^{b}, independently, represents an alkyl or aryl group, optionally containing one or more hetero atoms for instance O, N, S or P, with, for instance, 1-20 carbon atoms; such as diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl) dimethoxysilane (DiPDMS). More preferably, the external electron donor is chosen from the group of di(iso-propyl) dimethoxysilane (DiPDMS) or diisobutyl dimethoxysilane (DiBDMS).

Preferably, the external donor comprises or consists of a compound selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof, preferentially di(iso-propyl) dimethoxysilane (DiPDMS)

The compounds mentioned above as examples of the external electron donor are sometimes referred as Selectivity Control Agent (SCA). The external electron donor may consist of SCA. Alternatively, in addition to SCA, the external electron donor may further comprise compounds known as an activity limiting agent (ALA). Preferably, the Activity Limiting Agent (ALA) is selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof. More preferably, the Activity Limiting Agent (ALA) is isopropyl myristate.

The ratio of Selectivity Control Agent (SCA) to Activity Limiting Agent (ALA) is in principle not critical, best results are obtained for a SCA/ALA ratio in the range from 0.010 to 100, more preferably in the range from 0.10 to 20.

The molar ratio of Al in the co-catalyst to Si in the external electron donor may e.g. be 1 to 120.

In some preferred embodiments, the molar ratio of Al in the co-catalyst to Si in the external electron donor is more than 1, preferably more than 3, even more preferably more than 4 and at most 120, preferably at most 110, more preferably 90, more preferably at most 70, more preferably at most 60. the molar ratio of Al in the co-catalyst to Si in the external electron donor is in the range from 1 to 120, or 1 to 110 or 1 to 90 or 1 to 70 or 1 to 60, 3 to 60, or 3 to 90, or 4 to 90, or 4 to 70, or 4 to 60, or 5 to 120, or 5 to 110, or 5 to 90, or 5 to 70, or 5 to 60, or.

In some preferred embodiments, the molar ratio of Al in the co-catalyst to Si in the external electron donor is more than 15 and at most 120 or more than 20, or more than 25 and at most 120, or at most 100, or at most 90, or at most 70, or at most 60. The molar ratio of Al in the co-catalyst to Si in the external electron donor is in the range from 15 to 120, or 15 to 100, or 15 to 90 or 15 to 70, or 15 to 60, or 20 to 120, or 20 to 100, or 20 to 90, or 20 to 70, 20 to 60, or 25 to 120, or 25 to 100, or 25 to 90 or 25 to 70, or 25 to 60

In some embodiment the molar ratio of Al in the co-catalyst to Si in the external electron donor is in the range from 1 to 25, or from 1 to 14, or from 1 to 10, or from 3 to 10, or 3 to 14, or 3 to 20, or 3 to 25, or from 4 to 10, or 4 to 14, or 4 to 20, or 4 to 25, or from 5 to 10, or 5 to 14, or 5 to 20, or 5 to 25.

It is known in the common knowledge within the field of polypropylene catalysts that an increased molar ratio of Al/Si results in increased catalyst yield and a decrease of the isotacticity (and hence stiffness) of the polypropylene.

However, it has been surprisingly observed that the present invention allows to maintain high isotacticity while using a high molar ratio of Al/Si and having an increasedcatalyst yield.

### Catalyst Yield (CY) Ti*Prod Rate/Mass HoldUp:

In a preferred embodiment, the process has CY Ti (KgPP/gcat)*Production rate (Kg/h)/Mass Holdup (Kg) of at least 25, more preferably at least 30, more preferably at least 35, more preferably at least 40, wherein CY Ti (KgPP/gcat) is calculated following Equation (1):

$$CY Ti ( \frac{KgPP}{gcat} ) = \frac{Ti content in the catalyst ( \frac{g Ti}{g cat} )}{Ti content in th e polymer ( \frac{mg Ti}{Kg PP} )} * 1000 \qquad ( 1 )$$

wherein Ti content in the catalyst and Ti content in the obtained polymer is determined by Inductively coupled plasma mass spectrometry (ICP-MS).

Preferably, the amount of Ti in the propylene-based polymer is at most 1.1 mg per 1 kg of the propylene-based polymer as determined by Inductively coupled plasma mass spectrometry (ICP-MS)

### Composition

The polypropylene composition has a melt flow rate (MFR) in the range from 0.50 to 110 dg/min, wherein the melt flow rate is determined using ISO1133-1:2011 using 2.16 kg at 230° C. In some preferred embodiments, the MFR of the polypropylene composition determined using ISO1133-1:2011 using 2.16 kg at 230° C. is 0.50 to 30 dg/min. In some preferred embodiments, the MFR of the polypropylene composition determined using ISO1133-1:2011 using 2.16 kg at 230° C. is 30 to 110 dg/min.

Preferably, the amount of propylene-based polymer is at least 95 wt %, more preferably at least 96 wt %, even more preferably at least 97 wt %, even more preferably at least 98 wt % based on the polypropylene composition.

### Inorganic Filler

The composition according to the invention may comprise an inorganic filler. Suitable examples of the inorganic filler include but are not limited to talc.

The composition according to the invention may be free of or substantially free of an inorganic filler. For example, the composition according to the invention may comprise less than 1.0 wt %, less than 0.1 wt % or less than 0.01 wt % of an inorganic filler.

### Additives

In some embodiments, the polypropylene composition further comprises additives, for example in an amount of 0.10 to 2.0 wt % based on the polypropylene composition.

The additives include a stabilizer. The stabilizer may e.g. be selected from heat stabilizers, anti-oxidants and/or UV stabilizers, all of which are known to the person skilled in the art.

The additives may further include nucleating agents, colorants, like pigments and dyes; clarifiers; surface tension modifiers; lubricants; flame-retardants; mould-release agents; flow improving agents; plasticizers; anti-static agents; blowing agents; slip agents.

In one aspect, the invention provides an article comprising the polypropylene composition of the invention. Preferably, the amount of the polypropylene composition is at least 95 wt %, based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention relates to the use of the polypropylene composition of the invention for the preparation of an article. Preferably, the amount of the polypropylene composition is at least 95 wt % based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention provides a process for the preparation of an article comprising the steps of:
a. providing the polypropylene composition of the invention and
b. converting the polypropylene composition into an article, for example by using an extrusion or injection molding process

The invention further relates to use of the inventive polypropylene composition for compounding with a further polymer, for example a further polypropylene or for making masterbatches.

It is further noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Process for Preparation of Procatalyst

For inventive examples E2 to E6: the procatalyst was prepared according to the method disclosed in WO2021/063930A1, example 1

For Example E1: the procatalyst was prepared according to the method disclosed in WO2021/063930A1, example 1 but no external donor has been used. therefore this Example is not part of the invention.

For comparative examples CE1, the catalyst was prepared according to Comparative Example 1 in EP0728770B1 using a micropheroidal MgCl₂2.1EtOH support with an average particle size of 15 micron.

### Process Conditions for E1 to E5 and CE1

Gas-phase polymerizations were performed in one horizontally stirred gas-phase reactor (plus the secondary reactor blanketed) with downstream powder processing units (=degassing & catalyst deactivation) for powder collection.

The temperature of the powder bed is measured via a series of internal thermocouples. The data from these thermocouples is used to control the quench flow to the individual quench nozzles.

Hydrogen was fed to the reactor to control the melt flow rate.

The propylene homopolymer obtained was collected and its properties were measured.

### Process Conditions for E6

Gas-phase polymerizations were performed in a set of two horizontal, cylindrical stirred bed, gas phase reactors in series to prepare the heterophasic propylene copolymer E6.

The homopolymer was formed in the first reactor (R1) and an ethylene-propylene copolymer rubber in the second one (R2) to prepare a heterophasic propylene copolymer. Both reactors were operated in a continuous way.

During operation, polypropylene powder produced in the first reactor was discharged through a powder discharge system into the second reactor.

The temperature of the powder bed is measured via a series of internal thermocouples. The data from these thermocouples is used to control the quench flow to the individual quench nozzles.

Hydrogen was fed independently to both reactors to control a melt flow index ratio over the homopolymer powder and copolymer powder.

The propylene homopolymer from the first reactor was collected and its properties were measured.

Table 1 shows the catalyst used in the polymerization process as well as various properties of the homopolymers obtained.

TABLE 1
Reaction conditions of polymerization and polymer properties

| | E1 | E2 | E3 | E4 | E5 | E6 | CE1 |
|---|---|---|---|---|---|---|---|
| Co-catalyst | TEA | TEA | TEA | TEA | TEA | TEA | TEA |
| External donor | none | DiPDMS | DiPDMS | DiPDMS | DiPDMS | DiPDMS | DiPDMS |
| Al/Ti (mol/mol) | 110 | 110 | 110 | 110 | 110 | 200 | 38 |
| Si/Ti (mol/mol) | — | 1.8 | 2.8 | 3.7 | 5.5 | 40 | 3 |
| Al/Si (mol/mol) | — | 60 | 40 | 30 | 20 | 5 | 12.5 |
| Temp (° C.) | 68 | 68 | 68 | 68 | 68 | 68 | 68 |
| Pressure (Barg) | 22 | 22 | 22 | 22 | 22 | 22 | 22 |
| H2/C3 (mol/mol) | 0.0119 | 0.0119 | 0.0122 | 0.0124 | 0.0125 | 0.0160 | 0.0130 |
| MFR (dg/min) | 10 | 10 | 10 | 10 | 10 | 12.3 | 10 |
| CXS (wt %) | 2.72 | 1.71 | 1.87 | 1.63 | 1.81 | 1.2 | 2.3 |
| Pentad isotacticity (%) | 92.4 | 96.2 | 96.9 | 96.8 | 96.8 | 97.2 | 96.1 |
| Ti in powder (mg/kg) | 0.54 | 0.59 | 0.63 | 0.64 | 0.66 | 0.8 | 1.41 |
| CY Ti (kg PP/g cat)* Prod | 53.2 | 52.2 | 46.0 | 44.3 | 42.8 | 39.9 | 35.8 |
| Rate (Kg/h)/Mass HoldUp | | | | | | | |
| (Kg) | | | | | | | |
| Flex. Mod. (II) | N.A | N.A | N.A | N.A | N.A | N.A | N.A |
| Flex. Mod. (L) | N.A | N.A | N.A | N.A | N.A | N.A | N.A |
| Izod-n (II) | N.A | N.A | N.A | N.A | N.A | N.A | N.A |
| Izod-n (L) | N.A | N.A | N.A | N.A | N.A | N.A | N.A |
| Tensile Modulus | N.A | N.A | N.A | N.A | N.A | N.A | N.A |
| Tensile Strength | N.A | N.A | N.A | N.A | N.A | N.A | N.A |

Al/Ti is the molar ratio of the co-catalyst (TEA) to the procatalyst
Si/Ti is the molar ratio of the external donor (DiPDMS) to the procatalyst
Al/Si is the molar ratio of the co-catalyst (TEA) to the external donor (DiPDMS)
H2/C3 is the molar ratio of hydrogen to propylene
N.A: not analyzed

It can be seen that the process of E2-E6 made using the catalyst comprising the inventive procatalyst has a higher catalyst yield (indicated by CY Ti*Production rate/Mass Holdup) than CE1 made using a catalyst comprising a different procatalyst while resulting in compositions having a comparable stiffness as can be understood from the comparable values of the CXS and the isotacticity.

From the comparison of E2-E6, it can be seen that the higher Al/Si molar ratio (lower amount of Si (external donor)) in the catalyst resulted in a higher catalyst yield. In this regard, it is notable that E6 which uses a lower Al/Si molar ratio (higher amount of Si) in the catalyst than CE1 resulted in a higher catalyst yield than CE1. This shows the type of the procatalyst in the catalyst resulted in the difference in the catalyst yield.

From the comparison of E1 with E2 to E6, it can be see that the use of a Si external donor decrease the catalyst yield but remain higher than CE1.

Further, a lower amount of Ti was detected in E1 to E6 than CE1, meaning that polypropylene according to the invention contain less impurities that the one made with other catalyst as the one used in Comparative Example 1 in EP0728770B1 using a micropheroidal MgCl₂2.1 EtOH support with an average particle size of 15 micron. Accordingly, propylene produce by the process according to the invention may be suitable for application which require less impurity without further additional purification process.

### Measurement Methods

### MFR

The MFR was measured according to ISO1133 (2.16 kg/230° C.).

### Crystex Method for Propylene Homopolymer

The CRYSTEX method described below can determine the following properties of a PP homopolymer:
amount of crystalline insoluble fraction in the PP homopolymer (CXI equiv. whole sample; HT fraction);
amount of amorphous soluble fraction in the PP homopolymer (CXS equiv. whole sample)

The measurement of the properties may be performed according to CRYSTEX method by a CRYSTEX QC instrument of CRYSTEX QC Polymer Char (Valencia, Spain). A schematic representation of the CRYSTEX QC instrument is presented in Del Hierro, P.; Ortin, A.; Monrabal, B.; ‘Soluble Fraction Analysis in polypropylene, The Column’, February 2014. Pages 18-23.

The CRYSTEX QC instrument comprises an infrared detector (IR4) and an online 2-capillary viscometer. Quantification of HT fraction, LT fraction, TC2 whole, TC2-HT fraction, TC2-LT fraction can be done by the infrared detector which detects IR absorbance at two different bands (CH3 and CH2). IV whole, IV-HT fraction, IV-LT fraction can be determined by the online 2-capillary viscometer.

A sample of the PP homopolymer to be analyzed is weighed in concentrations of 10 mg/mL. After automated filling of the vial with 1,2,4-TCB containing 250 mg/L 2,6-tert-butyl-4-methylphenol (BHT) as antioxidant, the sample is dissolved at 170° C. until complete dissolution is achieved, for 60 min, with constant stirring of 800 rpm.

A defined volume of the sample solution is injected into the column filled with inert support where the crystallization of the sample and separation of the soluble fraction from the crystalline part takes place. This process is repeated twice.

During the first injection the whole sample is subjected to measurements at high temperature, for determining the IV whole [dl/g] and the TC2 whole (m/m %) of the PP homopolymer. The TC2, however, is not relevant for homopolymer PP.

During the second injection a measurement at low temperature is performed for determining the amorphous soluble fraction (CXS equiv. whole sample) (m/m %), followed by a measurement at high temperature for determining the crystalline insoluble fraction (CXI equiv. whole sample (m/m %)).

The crystalline insoluble fraction and the amorphous soluble fraction are separated through temperature cycles of dissolution at 165° C., crystallization at 40° C. and re-dissolution in 1,2,4-trichlorobenzene (1,2,4-TCB) at 165° C.

The CXS content is determined by calibrating the instrument with various PP polymers with known CXS content determined according to standard gravimetric method according to ISO16152.

### Isotacticity ¹³C NMR

175 mg of the polypropylene pellet was dissolved in 3 ml at 130° C. in deuterated tetrachloroethylene (C2D2Cl4) containing 2,6-Di-tert-butyl-4-methylphenol (BHT) (5 mg BHT in 200 ml C2D2CL). The ¹³C NMR spectrum was recorded on a Bruker Avance 500 spectrometer equipped with a cryogenically cooled probe head operating at 125° C.

The isotacticity of the mmmm pentad levels was determined from the ¹³C NMR spectrum in % based on the total pentad amount.

Catalyst yield (CY) Ti(KqPP/qcat)*Production Rate (Kq/h)/Mass HoldUp (Kq)

Ti content in the catalyst and Ti content in the obtained polymer were measured by ICP. The ICP procedure is as follows: Approximately 250 mg of each sample are digested in 6 mL concentrated nitric acid (trace metal grade) by microwave assisted acid digestion using an Anton Paar Multiwave PRO equipped with closed high pressure Quartz digestion vessels. After the microwave digestion run, the acid is analytically transferred into a pre-cleaned plastic centrifuge tube containing 1 mL of internal standard solution and is diluted with MilliQ water up to the 50 mL mark. The elements in the sample are quantified using a multi-element calibration set from Inorganic Ventures using an Agilent 8900 ICP-MS system.

Then, CY is calculated following Equation (1)

$$CY Ti ( \frac{KgPP}{gcat} ) = \frac{Ti content in the catalyst ( \frac{g Ti}{g cat} )}{Ti content in th e polymer ( \frac{mg Ti}{Kg PP} )} * 1000 \qquad ( 1 )$$

Production Rate (Kg/h) and Mass HoldUp (Kg) are measured.

Production Rate (Kg/h)/Mass HoldUp (Kg) corresponds to the polymer residence time.

### Ethylene Content

Ethylene content was measured using 13C-NMR spectroscopy. To this end, approximately 150 mg of material was dissolved in 1,1,2,2-tetrachloroethane-d2 (TCE-d2). To ensure a homogeneous solution, the sample preparation has been conducted in a heated rotary oven. The NMR measurements were carried out in the solution-state using a Bruker 500 Advance III HD spectrometer operating at 500.16 and 125.78 MHz for 1H and 13C, respectively, and equipped with a 10 mm DUAL cryogenically-cooled probe head operating at 125° C. The 13C-NMR experiments were performed using standard single pulse excitation utilizing the NOE and bi-level WALTZ16 decoupling scheme (Zhou Z. et al. J. Mag. Reson 187 (2007) 225. A total of 512 transients were acquired per spectrum. The spectra were calibrated by setting the central signal of TCE's triplet at 74.2 ppm. Quantitative 13C NMR spectra were processed, integrated and relevant quantitative properties determined from the integrals using proprietary computer programs.

Flex. Modulus (Parallel and Perpendicular Orientation)

For purpose of the present invention, stiffness of the granulate is determined by measuring the flexural modulus according to ASTM D790-10. Flexural modulus was determined on 3.2 mm thick specimens according to ISO37/2, parallel and perpendicular orientation.

### Izod Notched Impact Strength (Parallel and Perpendicular Orientation)

For purpose of the present invention, impact strength is determined by measuring the Izod notched impact strength of the granulate at 23° C. according to ISO180 4A, Test geometry: 65*12.7*3.2 mm, notch 45⁰ accordingto ISO37/2 parallel and perpendicular orientation.

### Tensile Test Method

For purpose of the present invention, the tensile properties were determined on 3.2 mm thick specimens according to ISO 527-2/5A.

1. Process for the preparation of a polypropylene composition comprising a propylene-based polymer which is a propylene homopolymer or propylene-ethylene copolymer having an ethylene content of less than 1.0 wt % based on the propylene-ethylene copolymer,
wherein the polypropylene composition has
a melt flow rate (MFR) in the range from 0.50 to 110 dg/min, wherein the melt flow rate is determined using ISO1133-1:2011 using 2.16 kg at 230° C.,
wherein the process comprises the step of polymerizing propylene and optional ethylene comonomers in the presence of a catalyst in a gas phase to obtain the propylene-based polymer, wherein said catalyst comprises a procatalyst, a co-catalyst and optionally an external electron donor, wherein the procatalyst is obtainable by a process comprising the steps of:
contacting a magnesium-containing support with a halogen-containing titanium compound, and an internal electron donor according to Formula I: 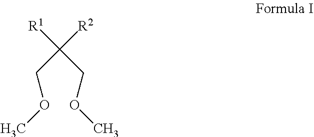
wherein R¹ is a secondary alkyl group and R² is a non-secondary alkyl group having at least 5 carbon atoms;
said procatalyst is prepared according to the following steps:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein X⁴ and X¹ are each independently selected from the group of consisting of fluoride (F—), chloride (Cl—), bromide (Br—) or iodide (I—); z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b}), —(OR³), or M²(OR^{b})_{v-w} (R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein w is smaller thanv;
iii) contacting the first or second intermediate reaction product, obtained respectively in step i) or ii), with a halogen-containing Ti-compound and said compound represented Formula I, as the internal electron donor.

2. Process according to claim 1, wherein the co-catalyst is selected from the group consisting of trimethylaluminum, triethylaluminum, triisobutylaluminum, trihexylaluminum, di-isobutylaluminum hydride, trioctylaluminium, dihexylaluminum hydride and mixtures thereof.

3. Process according to claim 2, wherein the catalyst comprises the external electron donor and wherein the molar ratio of co-catalyst to external electron donor is in the range from 1 to 25.

4. Process according to claim 2, wherein, the catalyst comprises an external donor, wherein the external electron donor is a silane containing external donor,
and
wherein, the molar ratio of Al in the co-catalyst to Si in the external electron donor is more than 1 and at most 120.

5. The process according to claim 1, wherein during step ii) as activating compounds an alcohol is used as activating electron donor and titanium tetraalkoxide is used as metal alkoxide compound.

6. The process according to claim 1, wherein an activator is present.

7. Process according to claim 1, wherein the amount of Ti in the propylene-based polymer is at most 1.1 mg per 1 kg of the propylene-based polymer as determined by Inductively coupled plasma mass spectrometry (ICP-MS).

8. Process according to claim 1, wherein the process has Catalyst yield (CY) Ti (KgPP/gcat)*Production rate (kg/h)/Mass Holdup (kg) of at least 25, wherein CY Ti (kgPP/gcat) is calculated following Equation (1):
$$CY Ti ( \frac{KgPP}{gcat} ) = \frac{Ti content in the catalyst ( \frac{g Ti}{g cat} )}{Ti content in th e polymer ( \frac{mg Ti}{Kg PP} )} * 1000 \qquad ( 1 )$$
the Ti content in the catalyst and Ti content in the obtained polymer is determined by Inductively coupled plasma mass spectrometry (ICP-MS).

9. Process according to claim 1, wherein the propylene-based polymer has a cold xylene soluble content (CXS) of 1.0 to 4.0 wt %, measured by the method described in the section “CRYSTEX method for propylene homopolymer” of the Measurement methods section of the present disclosure.

10. Process according to claim 1, wherein the propylene-based polymer has
a. a pentad isotacticity of at least 95.5 wt %, wherein the pentad isotacticity is determined using ¹³C NMR and/or
b. a melt flow rate of the propylene part of the propylene based polymer (MFR_{Hopol}), as determined according to ISO1133-1:2011 using 2.16 kg at 230° C. in the range from 2 to 100 dg/min.

11. Process according to claim 1, wherein the internal donor is 3,3-bis(methoxymethyl)-2,6-dimethylheptane and/or wherein the activating compound is N—N-dimethylbenzamide

12. Process according to claim 1, wherein the external donor comprises or consists of a compound selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof.

13. Process according to claim 1, wherein the external donor further comprises a compound selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof.

14. Polypropylene composition obtained by or obtainable by the process according to claim 1.

15. Polypropylene composition comprising a propylene-based polymer which is a propylene homopolymer or propylene-ethylene copolymer having an ethylene content of at most 1.0 wt % based on the propylene-ethylene copolymer,
wherein the polypropylene composition has a melt flow rate (MFR) in the range from 0.50 to 110 dg/min, wherein the melt flow rate is determined using ISO1133-1:2011 using 2.16 kg at 230° C., and
wherein the amount of Ti in the propylene-based polymer is at most 1.1 mg per 1 kg of the propylene-based polymer as determined by Inductively coupled plasma mass spectrometry (ICP-MS).

16. Article comprising the polypropylene composition of claim 14, wherein the amount of the polypropylene composition is at least 95 wt % based on the article and/or
wherein the article is prepared by injection molding and/or,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

17. The article of claim 16,
wherein the amount of the polypropylene composition is at least 95 wt % based on the article and
wherein the article is prepared by injection molding and,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

18. Process for the preparation of an article comprising the steps of
a. providing the polypropylene composition of claim 14 and
b. converting the polypropylene composition into an article, for example by using an extrusion or injection molding process.
